(19) United States
(12) Patent Application Publication
(10) Pub. No.: US 2009/0053348 A1
(43) Pub. Date: Feb. 26, 2009

(54) Injection Apparatus

(75) Inventors: Toshio Konishi, Chiba (JP); Yoshiyuki Imatomi, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 12/087,493

(22) PCT Filed: Jan. 23, 2007
(86) PCT No.: PCT/JP2007/050947

§ 371 Date: Jul. 8, 2008

(30) Foreign Application Priority Data
Jan. 23, 2006 (JP) 2006-04313

(51) Int. Cl. B28B 17/00

(52) U.S. Cl. 425/145

(57) ABSTRACT

In an injection apparatus of a molding machine, a bad influence given to a molded product due to a water component contained in a resin is eliminated by maintaining the resin immediately before being melted in a dry state. The injection apparatus has a cylinder (11) to which a molding material is supplied and a metering member (13) that meters the molding material by being driven in the cylinder (11). The cylinder (11) has a material supply opening (11b) through which the molding material is supplied. A dry gas, which has been heated at a predetermined temperature, is supplied to a vicinity of the material supply opening (11b) in the cylinder (11).

### TECHNICAL FIELD

The present invention relates to injection molding machines and, more particularly, to an injection apparatus that injects a resin by melting by a screw while heating within a cylinder.

### BACKGROUND ART

Generally, a granular or pellet-like resin is supplied from a hopper to a heating cylinder of an injection molding machine. A raw resin supplied to the heating cylinder is melted by being applied with a sharing force by a screw, which reciprocates while rotating in the heating cylinder. The melted resin is injected into a mold from a nozzle at an end of the heating cylinder.

Because a water component, if contained in the melted resin, gives a bad influence to a molded product, generally, a resin supplied to a hopper is dried so as to remove the water component before being supplied to the hopper. Normally, dehydration of a resin is performed by exposing the resin to a hot air of a predetermined temperature.

As a technique to supply a gas other than a hot air to a resin, there is suggested a technique to supply an inert gas to the resin supplied to a heating cylinder (for example, refer to Patent Document 1). The supply of an inert gas is to forcibly remove a gas generated from a melted resin so that gas bubbles are not contained in the melted resin. Additionally, it is suggested to supply an inert gas to a resin before being melted to remove oxygen so as to prevent the resin from being oxidized.

Patent Document 1: Japanese Laid-Open Patent Application No. 2004-50415

### DISCLOSURE OF THE INVENTION

### Problems to be Solved by the Invention

In a molding process of a normal size resin molded product, for example, a dehydrated resin supplied to a hopper of 1 litter volume is melted and injected entirely by a heating cylinder within several ten minutes or several hours if the molded products are continuously molded. However, if, for example, each molded product is extremely small (in a case that a shot volume is small), there is a case where only an amount of resin of about 100 g is used per day even if the molding is performed continuously. In such a case, a resin before being melted stays within a hopper and in the vicinity of a supply port of a heating cylinder for a long time.

If a resin before being melted stays within a hopper and in the vicinity of a supply port of a heating cylinder for a long time, there is a case where the resin is not maintained in the dehydrated state as the resin may absorb a water component again while staying. Especially, in an inline-type injection apparatus, a screw shaft extends from a rear side of a water-cooling cylinder, which is a part connected with a hopper, and it is possible that oxygen or a water component of an atmosphere enters from outside into the water-cooling cylinder through a gap between the screw shaft and the water-cooling cylinder.

As mentioned above, in a case of molding with a small shot volume, there is a problem in that a resin absorbs a water component again within a hopper or a water-cooling cylinder until the resin is melted even if the resin after subjected to a dehydrating process is supplied to the hopper. Depending on a kind of resin, such a water component may give bad influence to a molded product. For example, when a water component contained in a resin is injected from a gate part together with the melted resin, a radial line referred to as a silver streak may appear on the surface of the molded product. Such a silver streak does not only damage the external appearance of the molded product but also damages a function as an optical component, if the molded product is an optical component.

The present invention was made in view of the above-mentioned problems, and it is an object to provide an injection apparatus of a molding machine that can eliminate a bad influence given to a molded product due to a water component contained in a resin by maintaining the resin in a dehydrated state immediately before being melted.

### Means to Solve the Problems

In order to achieve the above-mentioned objects, there is provided according to one aspect of the present invention an injection apparatus having a cylinder to which a molding material is supplied and a metering member that meters the molding material by being driven in the cylinder, wherein the cylinder has a material supply opening through which the molding material is supplied, and the injection apparatus comprises means for supplying a dry gas, which has been heated at a predetermined temperature, to a vicinity of the material supply opening in said cylinder.

Additionally, there is provided according to another aspect of the present invention an injection apparatus having a cylinder to which a molding material is supplied and a metering member that meters the molding material by being driven in the cylinder, wherein the cylinder has a material supply opening through which the molding material is supplied, and the injection apparatus comprises means for supplying a dry gas, which is produced by compressing and dehumidifying a gas, to a vicinity of the material supply opening in said cylinder.

In the above-mentioned injection apparatus, is it preferable that said dry gas is a gas having the same composition as an ambient atmosphere. Alternatively, said dry air may be an inert gas. It is preferable that a humidity of said dry gas is lower than a humidity of an atmosphere in said cylinder.

In the above-mentioned injection apparatus, it is preferable that said cylinder has a dry gas supply passage located in a vicinity of said material supply opening to supply said dry air into said cylinder. Additionally, it is preferable that the said dry gas supply passage opens in said cylinder at a position lower than said material supply opening. Further, it is preferable that said dry gas supply passage opens in said cylinder at a position lower than said metering member. Further, it is preferable that said dry gas supply passage opens in said cylinder at a position displaced from said material supply opening in a moving direction of the molding material.

The above-mentioned injection apparatus may further comprise gas-discharging means for discharging a gas through said material supply opening.

### EFFECTS OF THE INVENTION

According to the present invention, because the dry gas is blown into the vicinity of the material supply opening of the cylinder, the resin staying in that part is exposed to the dry gas and is dehydrated. Accordingly, the resin, which is immediately before being melted in the cylinder, is maintained in a dehydrated state, and a bad influence due to a water component entering the melted resin is prevented from being given to the molded product.

### BRIEF DESCRIPTION OF DRAWINGS

FIG. 1 is an entire structure diagram of an electric injection molding machine provided with an injection apparatus according to an embodiment of the present invention.

FIG. 2 is a cross-sectional view of a heating cylinder of the injection apparatus shown in FIG. 1.

FIG. 3 is a cross-sectional view taken along a line III-III in FIG. 2.

FIG. 4 is a cross-sectional view of a heating cylinder in a case where a dry gas supply passage is arranged in the rear of a material supply port.

### EXPLANATION OF REFERENCE NUMERALS

10 injection apparatus

11 heating cylinder

11A cooling cylinder

11a material supply opening

11b material supply opening

12 hopper

13 screw

13a flight

20 mold-clamp apparatus

40 dry air supply apparatus

41 gas container

42 tank

43 heater

44 open/close valve

45 pipe

46 dry gas supply passage

47 seal member

### BEST MODE FOR CARRYING OUT THE INVENTION

Next, a description will be given, with reference to the drawings, of an injection apparatus according to an embodiment of the present invention.

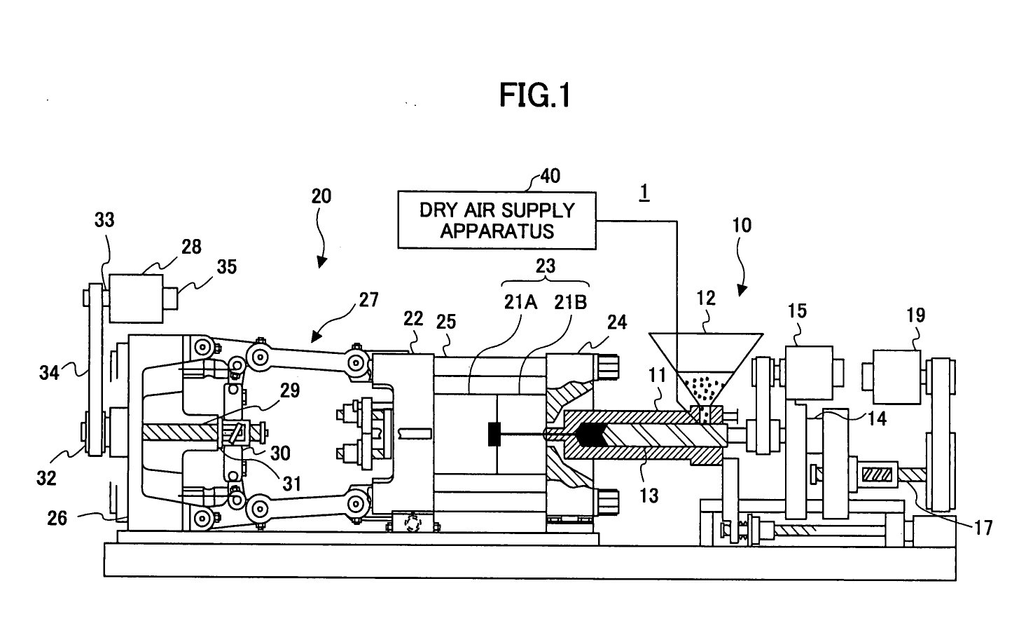

FIG. 1 is an entire structure diagram of an electric injection molding machine provided with an injection apparatus according to an embodiment of the present invention. First, the entire electric injection molding machine is explained briefly. The electric injection molding machine 1 shown in FIG. 1 comprises an injection apparatus 10 and a mold clamp apparatus 20.

The injection apparatus 10 is equipped with a heating cylinder 11, and the heating cylinder 11 is provided with a hopper 12. A screw 13 is provided movably forward and rearward and rotatably in the heating cylinder 11. A rear end of the screw 13 is rotatably supported by a support member 14. A metering motor such as a servomotor or the like is attached, as a drive part, to the support member 14. The rotation of the metering motor 15 is transmitted to the screw 13 as a driven part through a timing belt attached to an output shaft.

The injection apparatus 10 has a screw shaft 17 parallel to the screw 13. A rear end of the screw shaft 17 is connected to an output shaft of an injection motor 19. Accordingly, the screw shaft 17 can be rotated by the injection motor 19. A front end of the screw shaft 17 is engaging with a nut 31 fixed to the support member 14. If the injection motor 19 is driven and the screw shaft 17 is rotated through a timing belt, the support member 14 becomes movable forward and rearward, and, as a result, the screw 13 as a driven part can be moved forward and rearward.

The mold clamp apparatus 20 has a movable platen 22 to which a movable mold 21A is attached and a stationary platen 24 to which a stationary mold 21B is attached. The movable mold 21A and the stationary mold 21B together constitute a mold apparatus 23. The movable platen 22 and the stationary platen 24 are connected by tie bars 25. The movable platen 22 is slidable along the tie bars 25. Additionally, the mold clamp apparatus 20 has a toggle mechanism 27 of which one end connected to the movable platen 22 and the other end connected to a toggle support 26. A ball screw shaft 29 is rotatably supported in the center part of the toggle support 26. A nut 31 formed in a cross head 30 provided to the toggle mechanism is engaged with the ball screw shaft 29. Additionally, a pulley 32 is provided to a rear end of the ball screw shaft 29, and a timing belt 34 is provided between an output shaft 33 of a mold clamp motor 28 such as a servomotor and the pulley 32.

In the mold clamp apparatus 20, when the mold clamp motor 28, which is a drive part, is driven, the rotation of the mold clamp motor 28 is transmitted to the ball screw shaft 29 and the nut 31 through the timing belt 31. Then, the rotational motion is converted into a linear motion, and the toggle mechanism 27 is actuated. The movable platen 22 moves along the tie bars 25 due to the actuation of the toggle mechanism 27, and mold-closing, mold-clamping and mold-opening are performed. A position detector 35 is connected to a rear end of the output shaft 33. The position detector 35 detects a position of the cross head 30, which moves in association with the rotation of the ball screw shaft 29, or the movable platen 22, which is connected to the cross head 30 by the toggle mechanism 27.

In addition to the above-mentioned structure, the injection molding machine according to the present embodiment is provided with a dry air supply apparatus 40. The dry air supply apparatus 40 produces a dry gas mentioned later and supplies it to the heating cylinder 11. A resin supplied from the hopper 12 and staying in the heating cylinder 11 is set in a dehydrated state since a water component is removed by being exposed to the dry gas supplied from the dry gas supply apparatus. Accordingly, the resin staying in the heating cylinder 11 is fed forward by the screw while being maintained in the dehydrated state, and is melted and injected.

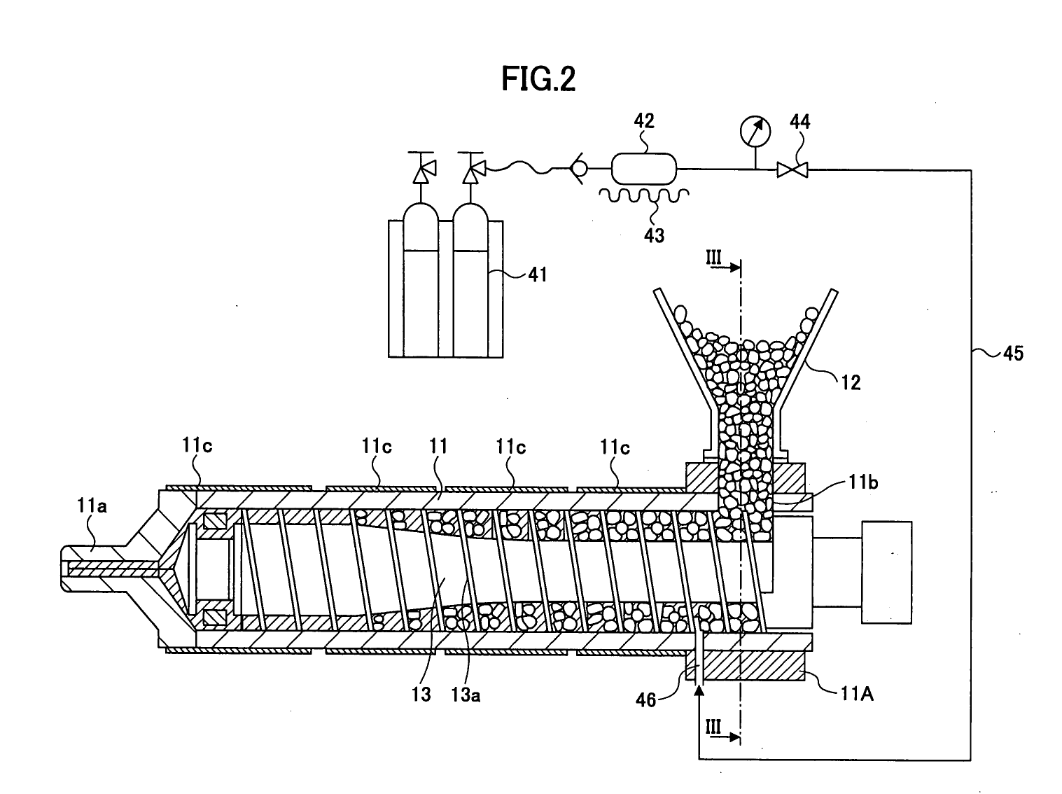

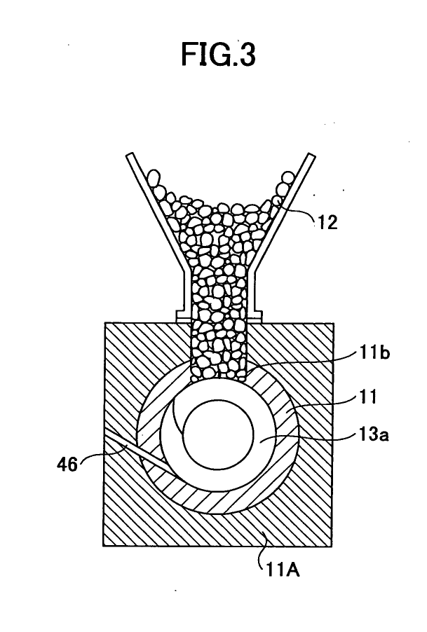

Next, a description will be given, with reference to FIG. 2 and FIG. 3, of the supply of the dry gas to the heating cylinder 11. FIG. 2 is a cross-sectional view of the heating cylinder 11, and dry air supply apparatus 40 is also shown. FIG. 3 is a cross-sectional view of the heating cylinder 11 taken along a line III-III line in FIG. 2.

First, a description will be give of a dry air supply apparatus 40. As mentioned above, the dry air supply apparatus 40 is an apparatus for supplying a dry gas to the heating cylinder 11 (more specifically, to the heating cylinder 11 through a cooling cylinder part 11A).

In the example shown in FIG. 2, the dry air supply apparatus 40 has a gas container 41 which stores the dry gas at a predetermined pressure. The dray gas discharged from the gas container 41 is fed to a tank 42 through a check valve, and is stored temporarily in the tank 42. A heater 43 is provided in the tank 42, which heats the dry gas in the tank 42 at a predetermined temperature. Here, the predetermined temperature is a temperature determined by the molding material (resin) supplied to the heating cylinder 11. More specifically, the predetermined temperature is a temperature previously determined so as to set the molding material to be used in a dehydrated state. For example, the predetermined temperature is about 80° C. to 120° C. if it is a normal resin. The dry gas heated at the predetermined temperature in the tank 42 is supplied to the heating cylinder 11 through a pipe 45.

The heating cylinder has a material supply opening 11b, and the resin supplied to the hopper 12 is supplied to the interior of the heating cylinder 11 through the material supply opening 11b. The screw 13 is arranged rotatably and reciprocally inside the heating cylinder 11, and the supplied resin is filled into a space between an inner wall of the heating cylinder 11 and a flight 13a formed in the screw 13. The resin as a molding material supplied to the heating cylinder 11 is moved in a forward direction of the heating cylinder, that is, in a leftward direction in FIG. 2, by the movement of the flight 13a in association with the rotation of the screw 13.

The heating cylinder 11 is provided with a plurality of heaters 11c so as to heat the heating cylinder 11 at a predetermined temperature. A resin being moved forward by the screw 13 in the heating cylinder 11 is heated by a heat from the heaters 11c. Additionally, a sharing force is applied to the resin in association with the movement of the resin due to rotation of the screw 13, and the resin is set in a melted state as moving forward in the heating cylinder 11. The resin is in a completely melted state at the distal end of the heating cylinder 11. Here, the melted resin is injected from a nozzle 11a at the end into the mold by moving the screw 13 forward.

In the heating cylinder 11, in a portion to which the resin is supplied from the hopper 12, it is necessary to maintain the temperature of the heating cylinder 11 to a predetermined temperature so that the resin is not melted or softened. For example, the predetermined temperature is about 80° C. Since the heating cylinder 11 is heated by the heaters 11a, it is necessary to cool the heating cylinder 11 to maintain the temperature at about 80° C. or lower in the portion to which the resin is supplied from the hopper 12. Thus, a cooling cylinder 11A is provided to a rear end of the heating cylinder 11, and the hopper 12 is attached to the heating cylinder 11 through the cooling cylinder 11A. A passage for flowing a cooling medium or a cooling water is formed in the cooling cylinder 11A to cool the rear end of the heating cylinder 11 by flowing the cooling medium or the cooling water so as to maintain the temperature equal to or lower than, for example, 80° C.

The dry gas supplied from the dry gas supply apparatus 40 is supplied to the interior of the heating cylinder 11 in the portion provided with above-mentioned cooling cylinder 11A. Therefore, in the example shown in FIG. 2, the dry gas supply passage 46 is formed by penetrating the cooling cylinder 11A and the heating cylinder 11. By the pipe 45 being connected to the dry gas supply passage 46, the dry gas heated at the predetermined temperature in the tank 42 is supplied to inside of the heating cylinder 11 through the pipe 45 and the dry gas supply passage 46 by the tank 42.

In the example shown in FIG. 3, the dry gas supply passage 46 is connected to the vicinity of the material supply opening 11b connected to the hopper 12. More specifically, the dry gas supply passage 46 extends from an under side of the cooling cylinder 11A, which is an opposite side of a portion where the hopper 12 is attached, and goes through to and opens in the inner surface of the heating cylinder 11. Accordingly, the position of opening of the dry gas supply passage 46 in the heating cylinder 11 is close to the material supply opening 11b and lower than the material supply opening 11b. Thereby, the dry gas heated at the predetermined temperature and supplied from the dry gas supply passage 46 turns into a hot air stream and flows upward while going through the gaps between the granular or pellet-like resin supplied in the heating cylinder 11, and flowing through the material supply opening 11b and released to a circumference from the hopper 12. Accordingly, the resin staying in a portion of the cooling cylinder 11A, especially, is exposed to the dry gas, and a water component in the resin is absorbed by the dry gas, and, as a result, the resin is set in a dehydrated state.

Moreover, the position at which the dry gas supply passage 46 opens in the heating cylinder 11 is a position ahead of the material supply opening 11b in the direction of the movement of the resin in the heating cylinder 11 (a position displaced in a direction of the nozzle 11a of the heating cylinder 11). This is to dehydrate the resin by supplying the dry gas from a position closer to the position where the resin begins to be softened or melted in the heating cylinder 11 as much as possible.

It should be noted that although the dry gas supply passage 46 is formed as a hole penetrating the wall part of the heating cylinder 11 in the above description, it is not limited to the hole penetrating the heating cylinder 11. For example, the dry gas supply passage can be achieved by a tube or a pipe for flowing the dry gas being inserted into the heating cylinder 11 through the material supply opening 11b. Alternatively, the dry gas may be supplied to the heating cylinder 11 by using a gap (clearance) formed between the heating cylinder 1 and the screw 13. As mentioned above, the means for supplying the dry gas includes various structures other than the dry gas supply passage 46 penetrating the wall part of the heating cylinder 11.

The dry gas may be supplied continuously to the heating cylinder 11, or may be supplied intermittently if the resin can be maintained in a dehydrated state by replacing a dry gas previously fed to the heating cylinder 11 by a dry air being newly fed.

Here, a description will be given of the dry gas supplied from the dry gas supply apparatus 40. The dry gas in the present invention can be any kind of gas if it is a gas which can absorb a water component from a resin while the air flowing in a circumference of the resin, and there is no limitation in temperature and humidity thereof. However, since the dry gas is released to the atmosphere of the location where the injection molding machine is installed, it is preferable that the dry gas is not toxic and is not flammable so that there is no risk of explosion. As for such a gas, there is an inert gas such as nitrogen, helium, etc. In a case where an inert gas is used, there is an effect in that oxygen is removed from the circumference of the resin, which prevents the resin from being oxidized. As an especially preferable gas, there is listed air which is a gas having the same composition as the surrounding atmosphere. For example, a water component contained in air may be reduced by heating the air at a high temperature by the heater 43 shown in FIG. 2. Further, a dry air having a dew point lower than that of air at a room temperature is produced by dehumidifying the air by compression to lower the dew point, and supply the dry air to the heating cylinder 11 through the dry gas supply passage.

In order to prevent the dry gas from being released to the atmosphere of the molding machine in a case where a gas different from the atmosphere of the molding machine is used, an upper opening of the hopper 12 may be closed and means for discharging the dry gas by suctioning the dry gas from the hopper 12 may be provided. That is, there is provided gas-discharging means for suctioning the dry gas through the material supply opening 11b of the heating cylinder 11 and discharging the suctioned dry gas. The suctioned dry gas is discharged to a place remote from the atmosphere of the molding machine such as, for example, outside of a building. In a case where the dry gas has toxic consequence, it may be discharged to outside after neutralizing or removing the toxicity.

As for a temperature of the dry gas, although it depends on a kind of the resin to be used, normally, 80° C. to 120° C. is preferable. If it is considerably lower than this temperature, the effect of dehydration is reduced. On the other hand, if it is considerably higher than this temperature, the resin may be softened or melted, or the temperature inside the cooling cylinder 11A is raised, and, thus, there is a problem in that a larger amount of cooling water must flow.

Additionally, as a humidity in a case where a dry air is used as a dry gas, there is an effect of absorbing a water component of a resin if it is lower than a humidity of the air inside the heating cylinder 11, but it is preferable to use an air dehumidified under an environment that a dew point temperature is −40° C. to 0° C. as a condition where a water component can be efficiently absorbed from a resin. However, an air produced by heating a normal room air at 80° C. to 120° C. also corresponds to the dry gas according to the present invention.

Next, a description will be given of the dry gas supply passage 46. If the dry gas supply passage 46 extends upward from the under-side of the heating cylinder 11, it is possible that a grain of a resin or a resin powder falls into the dry gas supply passage 46 as in the example shown in FIG. 2. Thus, as shown in FIG. 3, it is preferable to form the dry gas supply passage 46 to extend diagonally from above. In this case, since the opening of the dry gas supply passage 46 in the heating cylinder 11 faces downward, there is no possibility that a resin grain of a resin powder falls into the dry gas supply passage 46 due to gravity, and clogging of the dry gas supply passage 46 by the resin can be prevented.

In any of the example shown in FIG. 2 and the example shown in FIG. 3, the dry gas supply passage 46 opens in the heating cylinder 11 at a position in the vicinity of the material supply opening 11b and lower than the material supply opening 11b. Additionally, it is preferable that the position of the opening of the dry gas supply passage 46 is lower than the screw as a metering member in the heating cylinder 11. Further, as mentioned above, it is preferable that the position of the opening of the dry gas supply passage 46 is ahead of the material supply opening 11b in a direction of movement of the resin in the heating cylinder 11 (a position displaced in a direction of the nozzle 11a of the heating cylinder 11).

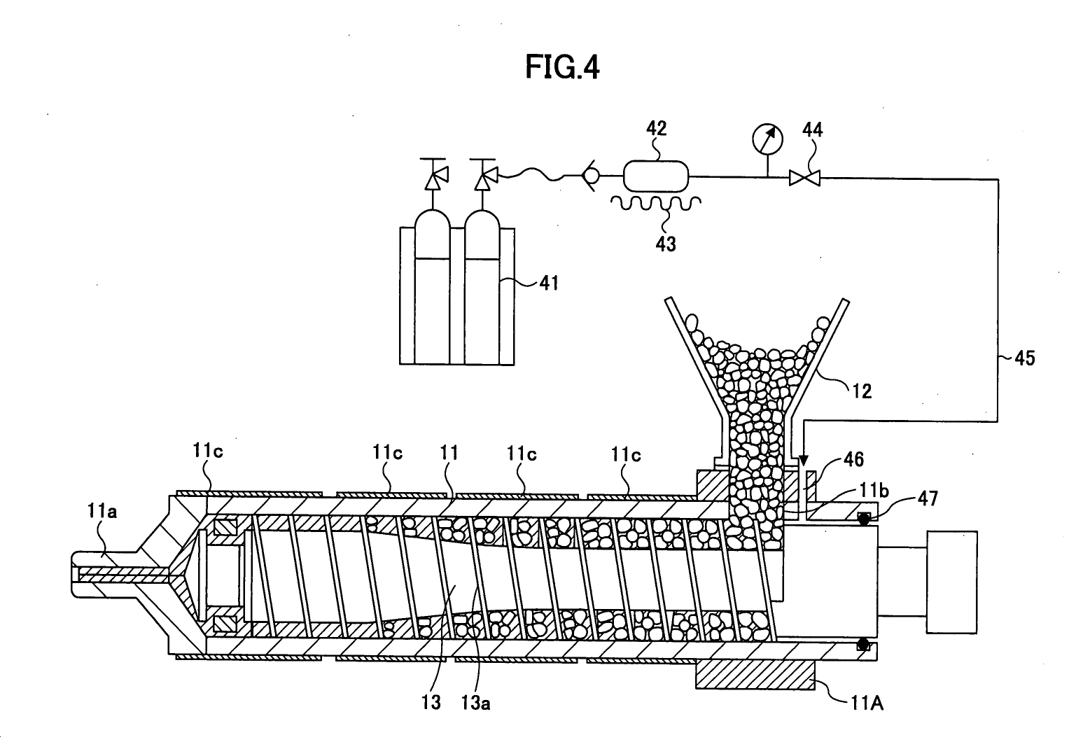

Additionally, as shown in FIG. 4, the dry gas supply passage 46 may be provided behind the material supply opening 11b. In such a case, since a space where there in no molding material even in a molding process is formed behind the material supply opening 11b, the dry gas supply passage 46 is prevented from being clogged by the molding material (resin) entering the passage. Further, a seal member 47 may be provided between the screw 13 and the heating cylinder 11 behind the dry gas supply passage 46. By providing the seal member 47, the space between the screw 13 and the heating cylinder 11 can be sealed, and the molding material can be set in a dehydrated state even if the dry gas supply passage 46 is provided behind the material supply opening 11b. Here, the seal member 47 is arranged at a position where the seal member 47 is brought into contact with the cylindrical portion of the screw 13 even if the screw 13 moves rearward.

It should be noted that, in the above-mentioned structure, the dry gas supply passage 46 provided in the heating cylinder 11 functions as means for supplying a dry gas to the heating cylinder 11. Although the dry air supply apparatus 40 may be included in the means for supplying the dray gas to the heating cylinder 11, the dry air supply apparatus 40 may supply a dry gas to, for example, a plurality of injection molding machines, and it is not always necessary to provide one dry air supply apparatus 40 to each injection molding machine (injection apparatus) and a dry gas may be supplied from one dry air supply apparatus 40 to a plurality of injection molding machines by connecting piping. That is, dry air supply apparatus 40 can be shared by a plurality of injection molding machines. Accordingly, as for an injection apparatus, it is considered that the dry gas supply passage 46 being formed in the heating cylinder 11 corresponds to the means for supplying a dry gas to the heating cylinder 11 being provided.

When connecting the piping from one dry air supply apparatus 40 to a plurality of injection molding machines and supplying a dry air, the expense concerning the structure of supplying the dry air can be reduced as an entire injection molding machine rather than attaching the dry air supply apparatus to each of the injection molding machines.

The present invention is not limited to the specifically disclosed embodiments, and variations and modifications may be made without departing from the scope of the present invention.

The present application is based on Japanese priority application No. 2006-014313 filed Jan. 23, 2006, the entire contents of which are hereby incorporated herein by reference.

### INDUSTRIAL APPLICABILITY

The present invention is applicable to an injection apparatus that melts and injects a resin by a screw while heating in a cylinder in an injection molding machine.

1. An injection apparatus having a cylinder to which a molding material is supplied and a metering member that meters the molding material by being driven in the cylinder,
wherein the cylinder has a material supply opening through which the molding material is supplied, and the injection apparatus comprises means for supplying a dry gas, which has been heated at a predetermined temperature, to a vicinity of the material supply opening in said cylinder.

2. An injection apparatus having a cylinder to which a molding material is supplied and a metering member that meters the molding material by being driven in the cylinder,
wherein the cylinder has a material supply opening through which the molding material is supplied, and the injection apparatus comprises means for supplying a dry gas, which is produced by compressing and dehumidifying a gas, to a vicinity of the material supply opening in said cylinder.

3. The injection apparatus as claimed in claim 1, wherein said dry gas is a gas having the same composition as an ambient atmosphere.

4. The injection apparatus as claimed in claim 1, wherein said dry air is an inert gas.

5. The injection apparatus as claimed in claim 1, wherein a humidity of said dry gas is lower than a humidity of an atmosphere in said cylinder.

6. The injection apparatus as claimed in claim 1, wherein said cylinder has a dry gas supply passage located in a vicinity of said material supply opening to supply said dry air into said cylinder.

7. The injection apparatus as claimed in claim 6, wherein said dry gas supply passage opens in said cylinder at a position lower than said material supply opening.

8. The injection apparatus as claimed in claim 6, wherein said dry gas supply passage opens in said cylinder at a position lower than said metering member.

9. The injection apparatus as claimed in claim 6, wherein said dry gas supply passage opens in said cylinder at a position displaced from said material supply opening in a moving direction of the molding material.

10. The injection apparatus as claimed in claim 1, further comprising gas-discharging means for discharging a gas through said material supply opening.
